(19) United States
(12) Patent Application Publication
(10) Pub. No.: US 2012/0173006 A1
(43) Pub. Date: Jul. 5, 2012

(54) USER INTERFACE DISPLAY OBJECT FOR LOGGING USER-IMPLEMENTED SOLUTIONS TO INDUSTRIAL FIELD PROBLEMS

(75) Inventors: Robert Joseph McGreevy, Oswego, IL (US); Michael John Pantaleano, Willoughby, OH (US); Bruce Gordon Fuller, Edmonton (CA); Ian Edward Tooke, Barrie (CA); Kevin John Albert, Elm Grove, WI (US); John Joseph Baier, Mentor, OH (US); Jan Pingel, New Berlin, WI (US)

(73) Assignee: ROCKWELL AUTOMATION TECHNOLOGIES, INC., Mayfield Heights, OH (US)

(21) Appl. No.: 13/416,450

(22) Filed: Mar. 9, 2012

Related U.S. Application Data
(63) Continuation of application No. 12/242,242, filed on Sep. 30, 2008.

(51) Int. Cl. G06F 17/40; G05B 9/02; G06F 17/30

(52) U.S. Cl. 700/80; 707/804; 707/E17.005; 707/E17.044; 707/E17.01

(57) ABSTRACT

A visualization system utilizing preconfigured process problem solution models and graphical solution objects to create operator implemented solutions to process problems. The visualization system provides for collecting and sharing the intelligence and experience of the operator in addition to the process data associated with the solution. The operator can include both operator movements around the process and equipment and voice commentary in the solution.

### CROSS-REFERENCE TO RELATED APPLICATIONS

This application is a continuation of U.S. patent application Ser. No. 12/242,242, filed Sep. 30, 2008, entitled “User Interface Display Object for Logging User-Implemented Solutions to Industrial Field Problems” which is hereby incorporated by reference in its entirety.

### TECHNICAL FIELD

The subject invention relates generally to industrial control systems, and more particularly to visualization systems that interact with industrial control systems based in part on collecting and archiving operator solutions to production and operational problems.

### BACKGROUND

Industrial controllers are special-purpose computers utilized for controlling industrial processes, manufacturing equipment, and other factory automation, such as data collection or networked systems. One type of industrial controller at the core of an industrial control system is a logic processor such as a programmable logic controller (PLC) or personal computer (PC) based controller. Programmable logic controllers for instance, are programmed by systems designers to operate manufacturing processes via user-designed logic programs or user programs. The user programs are stored in memory and generally executed by the PLC in a sequential manner although instruction jumping, looping and interrupt routines, for example, are also common. Associated with the user program are a plurality of memory elements or variables that provide dynamics to PLC operations and programs.

Connected to the PLC are input/output (I/I) devices. I/O devices provide connection to the PLC for both automated data collection devices such as limit switches, photoeyes, load cells, thermocouples, etc. and manual data collection devices such as keypads, keyboards, pushbuttons, etc. Differences in PLCs are typically dependent on number of I/O they can process, amount of memory, number and type instructions and speed of the PLC central processing unit (CPU).

Another type of industrial controller at the core of an industrial control system is the process controller of a distributed control system (DCS). The process controller is typically programmed by a control engineer for continuous process control such as an oil refinery or a bulk chemical manufacturing plant. A control engineer typically configures control elements such as proportional-integral-derivative (PID) control loops to continuously sample the I/O data, known as the process variable, from the process, compare the process variable to a configured set point and output an error signal, proportional to the difference between the set point and the process variable, to the control device. The control device then adjusts the element controlling the process property, such as a valve in a pipe for flow control or a heating element in a distillation column for temperature control, in an attempt to minimize the error signal. As the DCS name implies, many process controllers are distributed around the process and are communicatively coupled to each other forming the overall control system.

Connected to the process controller are similar types of I/O devices as connected to the PLC and additionally, intelligent I/O devices more common to the process control industry. These intelligent devices have embedded processors capable of performing further calculations or linearization of the I/O data before transmission to the process controller.

A visualization system is generally connected to the industrial controller to provide a human-friendly view into the process instrumented for monitoring or control. The user of a visualization system configures one or more graphical displays representing some aspect of the process the industrial controller is controlling or monitoring. The graphical displays each contain a user configured number of data values collected from the I/O connected to the industrial controller and considered by the user as relevant to the particular graphical display or process area of interest. Other data points may be configured strictly for archival purposes or to generate reports related to interests such as production, downtime, operator efficiency, raw material usage, etc.

Although the visualization system effectively represents the process of interest and provides a means for the operator to monitor or control the process, the intelligence to troubleshoot the process, recognize patterns that will most probably lead to downtime or determine the most expedient action to take to return the process to optimal operating conditions remains knowledge held by the operator. Operators develop an intimate understanding of the process and its unit operations over long periods of time spent managing operations. During this time, the operator, through experience, develops a feel for whether the process is operating at peak efficiency based on familiarity with the process. In some cases a visualization system can collect relevant data but in many cases, without the operators' guidance, it is difficult or impossible to associate a particular set of process conditions with a particular process problem.

The recognition of the magnitude of the importance of operator experience is sometimes not known until an operator has retired or left the process area for other opportunities. Accordingly, market pressure to capture the knowledge accumulated by operators has led to a desire to provide a mechanism to incorporate the experience intelligence of the operator into the visualization system.

### SUMMARY

The following presents a simplified summary in order to provide a basic understanding of some aspects described herein. This summary is neither an extensive overview nor is intended to identify key/critical elements or to delineate the scope of the various aspects described herein. Its sole purpose is to present some concepts in a simplified form as a prelude to the more detailed description presented later.

A visualization system is communicatively coupled to an industrial control system and configured with a series of display graphics. The graphics are designed to represent the process under control and provide the ability to display current process conditions and download data to the industrial controllers. The visualization system also provides the ability for the user to configure solutions to typical process problems and downtime conditions. The operator, upon detecting a particular process issue, can select an appropriate problem solution to inform the visualization system of the general solution to the problem. Additionally, the user may configure an object on one or more graphic displays that allow the operator to select the object when a solution to the process problem has been obtained.

The solution to the process problem can include the recordation of data available to the industrial control system through the automated input/output modules, the input of manual data into the visualization system by the operator and the selection of a preconfigured process problem solution. In addition to information collected based on process data, information related to operator actions can be collected both automatically and manually. The operator can wear a location sensing device that allows the visualization system to track the movements of the operator and create a chronological sequence of events recording the order the operator checks or corrects process conditions. The operator can wear a voice recording and transmission device allowing the operator to include verbal instructions or observances directly into the archived problem solution.

The culmination of a process problem solution includes the process data collected by the visualization system in temporal proximity to the occurrence of the problem, the preconfigured process solution selected by the operator and the operator activity information collected from operator movements or voice interaction. The nexus of this problem identification and solution information collection cycle occurs when the operator instructs the visualization system to assimilate the information and associate it with a particular process problem. The operator initiates the process problem data collection sequence with a single click of the mouse on the solution object created on the graphic display or a particular pre-defined phrase spoken to the voice recording system.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates an embodiment of a visualization system for invoking a one-click process problem solution archive system.

FIG. 2 illustrates an embodiment of a visualization system for invoking a one-click process problem solution archive system where an interface component allows the collection of automated data and manual data.

FIG. 3 illustrates an embodiment of a visualization system for invoking a one-click process problem solution archive system where a visualization component allows the creation, configuration and display of graphic images.

FIG. 4 illustrates an embodiment of a visualization system for invoking a one-click process problem solution archive system where a solution logging component allows the data logging based on process data, operator speech and operator movements.

FIG. 5 illustrates an embodiment of a visualization system for invoking a one-click process problem solution archive system where a logging activation component allows the operator to initiate the solution data logging based on interaction with a graphic display object, operator movement or operator speech.

FIG. 6 illustrates an embodiment of a visualization system for invoking a one-click process problem solution archive system where a storage component allows the visualization system to store process problem solution data and preconfigured process problem solution models.

FIG. 7 illustrates a methodology of a visualization system where the system is configured and the operator determines when to activate the problem solution data capture.

FIG. 8 illustrates a methodology of a visualization system where the operator chooses which method to activate the data capture mode.

FIG. 9 illustrates a methodology of a visualization system where the user creates the graphic displays, including the solution object and selects a representative preconfigured solution.

FIG. 10 illustrates an embodiment of the visualization system depicting an operator wearing the devices allowing location detection.

FIG. 11 illustrates an embodiment of the visualization system depicting an operator wearing the devices allowing voice recording and activation.

FIG. 12 illustrates an embodiment of the visualization system depicting a typical computing environment.

FIG. 13 illustrates an embodiment of the visualization system depicting the interaction between a visualization client and a visualization server.

FIG. 14 illustrates an embodiment of the visualization system depicting the interaction between multiple visualization clients.

### DETAILED DESCRIPTION

Systems and methods are provided enabling the user to configure a visualization system to allow the operator to instruct the visualization system when to collect process problem solution data with a single click of the mouse, selection of a keystroke, body movement or spoken preconfigured word or phrase. The operator can also select a preconfigured process problem solution as a background for the data collection to allow the visualization system to create a database of preconfigured process problem solutions of greater detail and specificity. As the process problem solutions evolve, they can be communicatively distributed to data servers or other visualization systems to provide a larger database of possible preconfigured process problem solutions.

In one aspect of the subject disclosure, the preconfigured profiles and templates represent the accumulation of process operating knowledge collected from a series of operators over time. In another aspect of the subject disclosure, as the process changes with the addition of new equipment and other products requiring different process parameters, the visualization system provides for an easy one-click mechanism for the operator to evolve the process problem solution database. Another aspect provides for a continuity of process understanding by allowing the transition from one operator to another without losing the experience acquired by the operator over their time with the process. The one-click process problem solution visualization system also allows for the presence of process engineers or experts to occasionally assist in specific process problem diagnostics and solutions and the inclusion of their results in the process problem visualization system database with the same one-click ease.

It is noted that as used in this application, terms such as “component,” “display,” “interface, ” and the like are intended to refer to a computer-related entity, either hardware, a combination of hardware and software, software, or software in execution as applied to an automation system for industrial control. For example, a component may be, but is not limited to being, a process running on a processor, a processor, an object, an executable, a thread of execution, a program and a computer. By way of illustration, both an application running on a server and the server can be components. One or more components may reside within a process and/or thread of execution and a component may be localized on one computer and/or distributed between two or more computers, industrial controllers, and/or modules communicating therewith. Additionally, it is noted that as used in this application, terms such as “system user,” “user,” “operator” and the like are intended to refer to the person operating the computer-related entity referenced above.

As used herein, the term to “infer” or “inference” refer generally to the process of reasoning about or inferring states of the system, environment, user, and/or intent from a set of observations as captured via events and/or data. Captured data and events can include user data, device data, environment data, data from sensors, sensor data, application data, implicit and explicit data, etc. Inference can be employed to identify a specific context or action, or can generate a probability distribution over states, for example. The inference can be probabilistic, that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

It is also noted that the interfaces described herein can include a Graphical User Interface (GUI) to interact with the various components for providing industrial control information to users. This can include substantially any type of application that sends, retrieves, processes, and/or manipulates factory input data, receives, displays, formats, and/or communicates output data, and/or facilitates operation of the enterprise. For example, such interfaces can also be associated with an engine, editor tool or web browser although other type applications can be utilized. The GUI can include a display having one or more display objects (not shown) including such aspects as configurable icons, buttons, sliders, input boxes, selection options, menus, tabs and so forth having multiple configurable dimensions, shapes, colors, text, data and sounds to facilitate operations with the interfaces. In addition, the GUI can also include a plurality of other inputs or controls for adjusting and configuring one or more aspects. This can include receiving user commands from a mouse, keyboard, speech input, web site, remote web service and/or other device such as a camera or video input to affect or modify operations of the GUI.

Additionally, it is also noted that the term industrial controller as used herein includes both PLCs and process controllers from distributed control systems and can include functionality that can be shared across multiple components, systems, and or networks. One or more industrial controllers can communicate and cooperate with various network devices across a network. This can include substantially any type of control, communications module, computer, I/O device, Human Machine Interface (HMI)) that communicate via the network which includes control, automation, and/or public networks. The industrial controller can also communicate to and control various other devices such as Input/Output modules including Analog, Digital, Programmed/Intelligent I/O modules, other programmable controllers, communications modules, and the like. The network (not shown) can include public networks such as the Internet, Intranets, and automation networks such as Control and Information Protocol (CIP) networks including DeviceNet and ControlNet. Other networks include Ethernet, DH/DH+, Remote I/O, Fieldbus, Modbus, Profibus, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

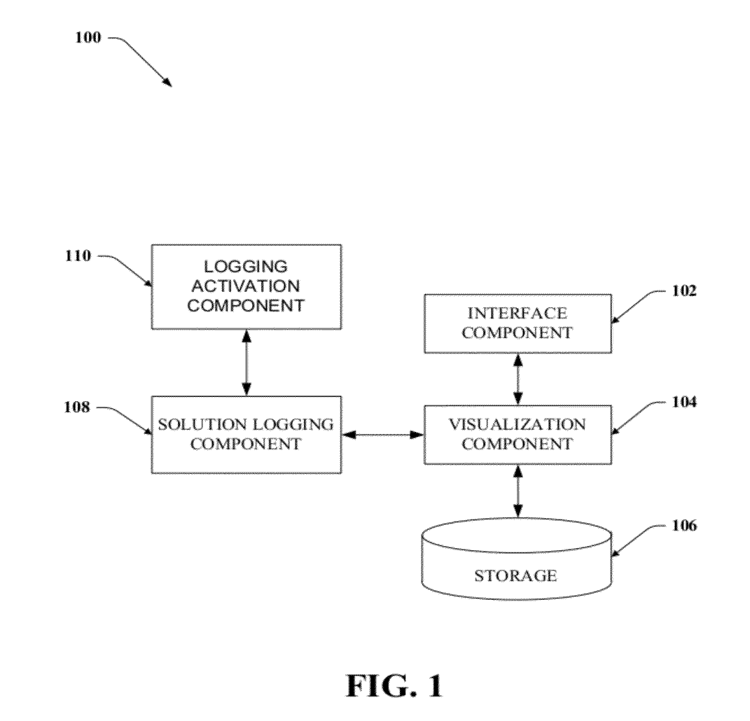

Referring initially to FIG. 1, a process problem solution visualization system 100 for archiving a solution to a process problem from the process data and the operator's experience for an industrial automation system is depicted. It should be appreciated that even though an industrial control system controls the process and allows for the archiving of enormous amounts of process data, many of the solutions to process problems hinge on the operator's detailed and intimate knowledge of the process and the operating equipment. Visualization process problem solution system 100 addresses this need by providing preconfigured process problem solutions and a simple one-click design for the operator to capture both process and operator data related to solving a process operation problem.

It is contemplated that visualization process problem solution system 100 can form at least part of a human machine interface (HMI), but is not limited thereto. For example, the visualization process problem solution system 100 can be employed to facilitate creating a visualization system related to automation control systems, devices, and/or associated equipment (collectively referred to herein as an automation device(s)) forming part of a production environment. Visualization process problem solution system 100 includes interface component 102, visualization component 104, storage component 106, solution logging component 108 and logging activation component 110.

The interface component 102 is communicatively connected to Input/Output devices. The interface component 102 provides for object or information selection, input can correspond to entry or modification of data. Such input can affect the configuration, graphic display, reports and/or automation devices. For instance, an operator can select the problem solution object to instruct the visualization process problem solution system 100 to collect and archive process problem solution data. Additionally or alternatively, a user could modify automation device parameters or provide a verbal description of the series of steps the operator used to diagnose the problem. By way of example and not limitation, a conveyor motor speed set point could be increased or decreased and the operator could state that the conveyor was set on a speed inappropriate for the particular product in manufacture. It should be noted that input need not come solely from a user, it can also be provided by automation devices. For example, warnings, alarms, and maintenance schedule information, among other things, can be provided with respect to displayed devices.

The interface component 102 receives input concerning displayed objects and information. Interface component 102 can receive input from a user, where user input can correspond to object identification, selection and/or interaction therewith. Various identification mechanisms can be employed. For example, user input can be based on positioning and/or clicking of a mouse, stylus, or trackball, and/or depression of keys on a keyboard or keypad with respect to displayed information. Furthermore, the display device may be by a touch screen device such that identification can be made based on touching a graphical object. Other input devices are also contemplated including but not limited to gesture detection mechanisms (e.g., pointing, gazing . . . ) and voice recognition.

The interface component 102 may also receive automated input data from the industrial controller which in turn has received input data from the various devices communicatively connected to the industrial controller. Examples of this input data are temperatures, pressures, flow rates, mass, volume, elapsed time counts and other such information available from an industrial process. The interface component 102 may also transmit modified data to the industrial controller(s) to reflect any changes made by the solution logging component 108 or the logging activation component 110. For example, if the operator changed the value of a set point for a PID control loop in a preconfigured process problem solution, the change could be transmitted to the industrial controller implementing this PID control loop. In another example, the interface component 102 can transmit an updated preconfigured production problem solution to another operator located at another computer communicatively coupled to the computer updating the production problem solution.

The visualization component 104 presents the configured displays to the operator for monitoring and controlling the process. One or more of the configured displays contain solution objects supporting the one-click functionality of the visualization system. For example, the display graphic can have a button labeled “Archive Solution” for the operator to click when it is time to collect process and operator data for the identified problem. In another example, the operator can click the button if the selected preconfigured solution most closely matches the problem at hand. In another example, clicking on the solution button can collect the process and operator data and add it to the preconfigured solution before archiving to the storage component 106.

The visualization component also provides the ability to create the graphic images representing the process, including the solution object. The visualization component is communicatively coupled to the solution logging component allowing solution logging component to identify the process area of interest based on the selection of the solution component.

The storage component 106 provides the ability to archive preconfigured process problem solutions, preconfigured visualization systems including displays, reports and recipes and user configured components of the visualization system 100. Additionally, any process problem solutions logged by the visualization system 100 are archived on the storage component and can be communicated to server data stores 1330 or other visualization system clients 1310.

In another aspect, process data is maintained on the storage component 106 for future review with regards to creating new preconfigured process problem solutions or updating existing preconfigured process problem solutions. The storage component 106 can automatically transfer its database of preconfigured process problem solutions to other server data stores or visualization system clients based on a timed schedule an event such as the modification of a preconfigured process problem solution. For example, if an operator discovers a new parameter associated with a particular process problem and archives the new parameter and the required solution to the storage database 106, the visualization system 100 will automatically update all other visualization systems containing the preconfigured process problem solution. In this manner, the efficiency of the overall operation is improved because any given process problem must be solved only once. If the particular process problem occurs at another location then the operator at that location can select the preconfigured process problem solution and resolve the problem without the time consuming and costly step of analyzing the problem. Through this method, a newly hired operator at one facility can exploit the expertise of the replaced operator or an experienced operator at another facility.

The solution logging component 108 provides methods and functionality allowing the user to assimilate process and operator data related to the solution of a particular process problem. The solution logging component can collect process data communicatively coupled to the visualization system from the industrial controller or from manual data entry devices communicatively couple to the visualization system 100. In another aspect the solution logging component can collect data related to operator expertise from the operator through one or more devices worn by the operator to track operator movements. In another aspect the solution logging component 108 can collect operator verbal information and diagnostics as spoken by the operator into a recording device communicatively coupled to the solution logging component. It is understood that these methods are not mutually exclusive and can be used in any combination.

The logging activation component 110 provides the user interface allowing the operator to initiate the solution data collection. The operator has several choices to initiate the solution data collection. In one aspect, the operator can click on the solution object located on a graphic display. The object represents a one-click button providing a quick and easy mechanism for the operator to acknowledge that a solution to the current process problem is identified and data concerning this solution should be collected and archived.

In another aspect, the operator can perform one or more movements preconfigured on the visualization system 100 to indicate that the operator desires the visualization system to collect problem solution data. This method results in the same data collection as the one-click button described above but does not require the operator to return to the visualization system to activate the operation. This is important in certain circumstances where the operator cannot leave the specific area of the problem before the problem is corrected but desires to collect problem solution data before circumstances change resulting in loss of part or all of the problem solution data.

In another aspect, the operator can verbalize both data and commands to a microphone communicatively coupled to the solution logging component 108. As with the operator movement implementation described above, the voice activated system allows the operator to add his expertise to the solution and archive the updated solution to the process problem without the requirement of returning to the visualization system for user interaction.

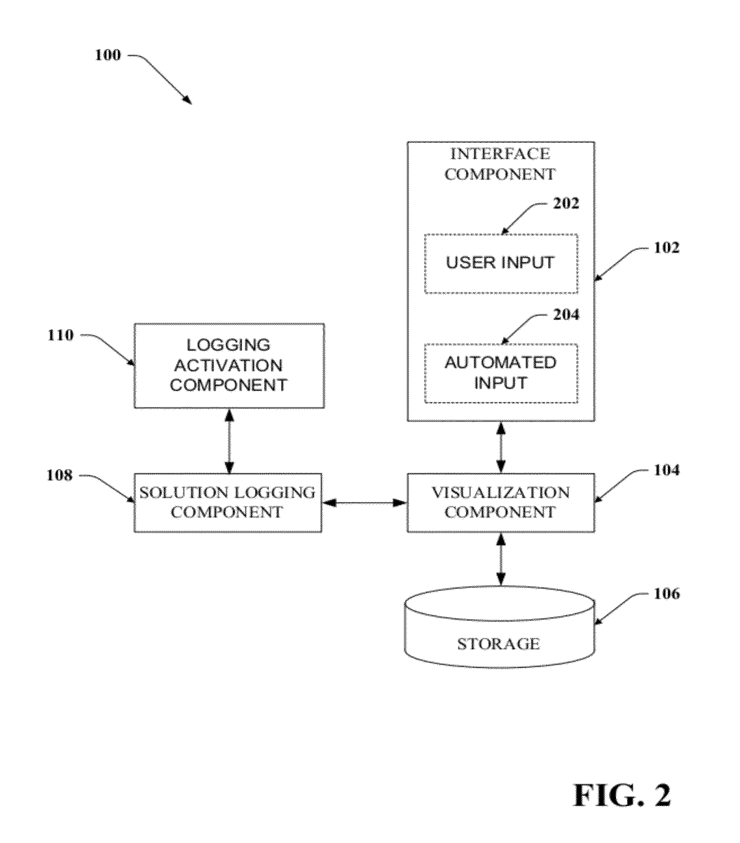

Referring next to FIG. 2, the interface component 102 includes user input component 202 and automated input component 204. In one aspect, user input component 202 provides the capability for an operator to input manual data related to and describing a solution to a particular process problem. The operator can add this information either before or after selecting the solution object to archive a solution to a particular process problem. For example, while the operator was analyzing a process problem at a particular machine, a verbal command was sent by the operator to archive the process problem solution data. At a later time, when the process is again operating as intended, the operator, using the user input component 202, can add additional information or comments to the process problem solution to further describe the solution or extend the solution to other aspects or machines of the process. The enhanced solution can then be communicated to other servers or visualization systems to decrease overall production downtime by providing greater insight into the process problem solution.

In another aspect, the automated input component 204 responds to the operators' indication to collect the information for the process problem solution by collecting the process data associated with the selected process problem model. For example, if the operator has selected a particular problem model as similar to the problem at hand, when the operator indicates it is time to collect the process problem solution data then the automated input module 204 will collect all the automated data associated with the particular process problem model and include this data in the archive.

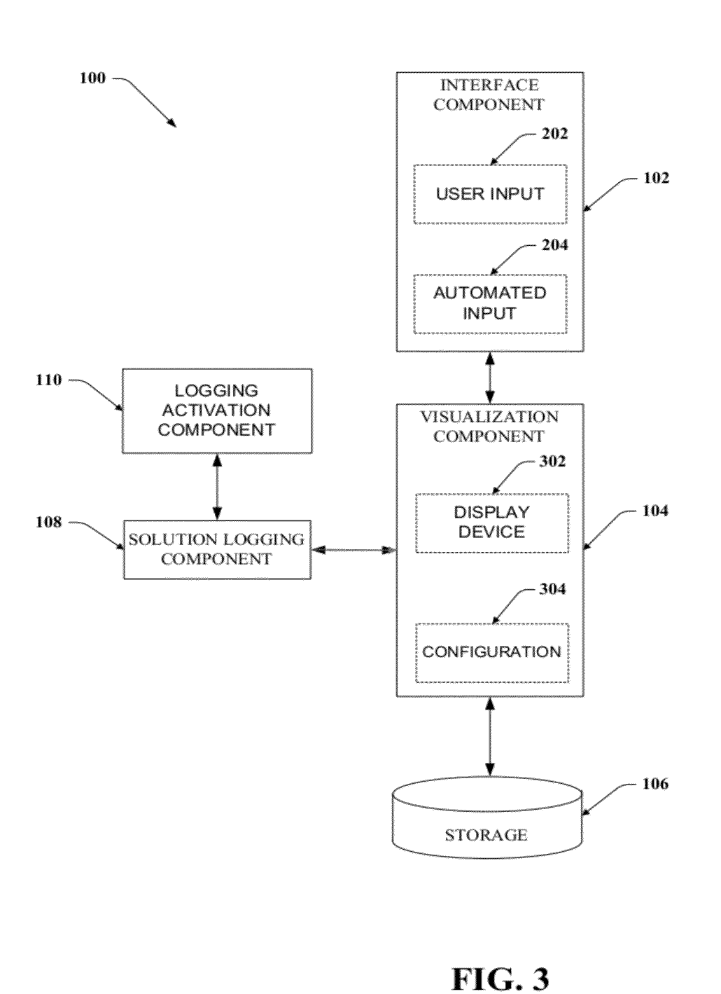

Referring next to FIG. 3, the visualization component 104 includes a display device component 302 and a configuration component 304. In one aspect, the display device component 302 provides a device for rendering a graphic image allowing the operator to monitor the process. A part of the graphic image includes the graphical representation of the solution object for operator interaction. The solution object can appears as any shape the user desires to represent the object. For example, the user can configure a button labeled “Log Solution” and when the operator clicks on the button, the solution object is activated and proceeds to collect the process problem solution data based on the selected preconfigured process problem model. It should be noted that the solution object can be represented as any shape configurable by the visualization system and the operator may select other methods of activating the solution object such as operator movement or voice command.

In another aspect, the configuration component 304 provides for creating graphical displays representing the process and equipment of interest. A part of creating the graphical display can include creating a solution object for inclusion on the graphical display. Configuring the solution object can include selecting process problem models for later use by the solution object. The solution object can select a particular process problem solution based on the location of the operator when the solution object is activated, a verbal command from the operator or a selection by the operator with a mouse click on the solution object.

Configuration component 304 can also allow the configuration of the collection of specific data as part of the solution object configuration. For example, as an operator becomes more familiar with a process and its behavior, specific data can become known as relevant to a particular process problem model. The configuration component 304 provides the ability to define the specific data to collect when the solution object is activated. In another aspect, the configuration component 304 can provide for the operator to modify the collection strategy at the time the solution object is activated. For example, in diagnosing a particular problem on a new piece of equipment, the operator may learn that a different data set is more relevant to the problem solution and either select a different process problem model or modify the data collection strategy of the currently selected process problem model.

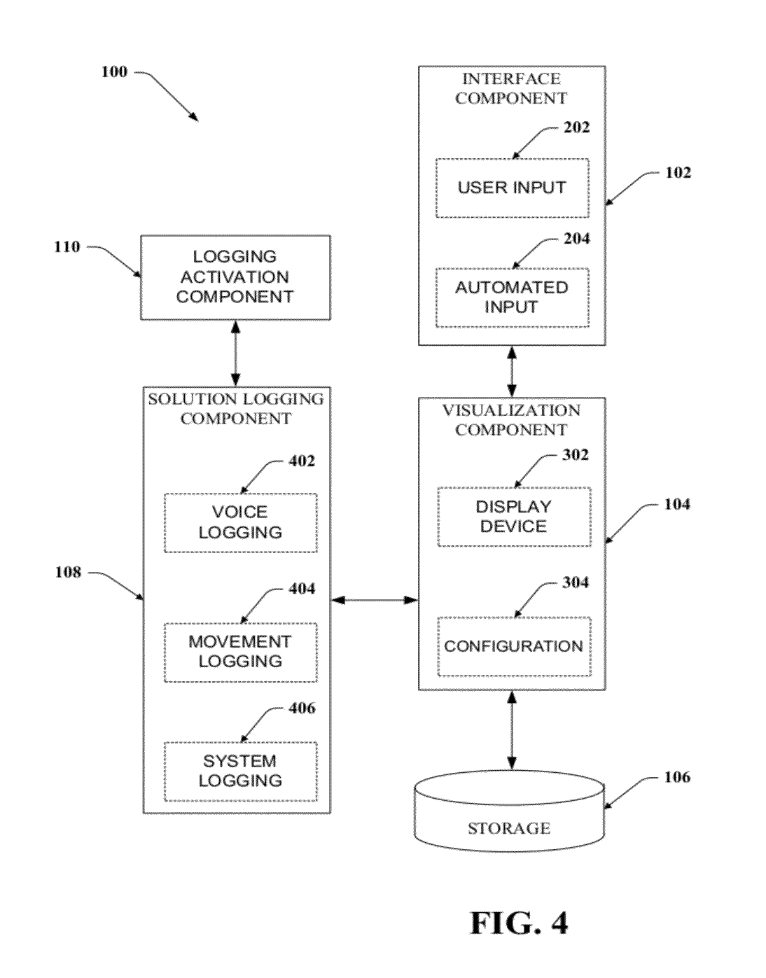

Referring to FIG. 4, the solution logging component 108 includes voice logging component 402, movement logging component 404 and system logging component 406. In one aspect, the voice logging component allows the visualization system 100 to accept voice commands and data from the operator. In one embodiment, the operator wears a microphone connected to a transmitter. A receiver compatible with the transmitter is connected to the visualization system 100 allowing the operator to move about the manufacturing area to analyze and solve operational problems while maintaining the ability to provide data and commands to the visualization system. For example, if the operator determines that a misaligned guide rail on a canning line is resulting in frequent line jamming downtime, the operator can communicate the data related to the location and corrective action to eliminate the line jamming problem and invoke the solution object to record the process problem solution data.

In another aspect, microphones can be place in strategic locations around the process area and wired directly to the visualization system 100 providing a more reliable communication mechanism in an electrically noisy environment. In this implementation, the operator would report to the most convenient microphone and communicate similar data and commands to solve the problem and invoke the solution object.

The voice interactive system provides the specific benefits of allowing the operator to instruct the system and invoke commands simultaneously with analyzing and a problem and monitoring the result of the solution and the operator remains hands free and focused on the primary task of maintaining process operation while reducing the risk that valuable process data will be lost as a result of being deferred until the process problem is resolved.

The movement logging component 404, in another aspect of the subject invention, provides the ability of the visualization system 100 to track the movements of the operator as the process problem is analyzed and a solution is determined. For example, as a means of developing a training program for new operators, the method an experienced operator uses to diagnose a particular class of process problems can be presented based on the order the operator evaluates the different operations of the process. If a line jam has occurred and the line shuts down, the visualization system tracks the movement of the experienced operator to determine the most efficient series of checks to determine the jam location. In a later analysis of this data, a determination can be made if more sensing devices are warranted to allow for the automated determination of this particular class of line jam, leading to a more efficient operation of the process.

In another aspect of movement logging, the visualization system 100 can provide for configured movements indicating predefined commands. For example, a predefined command might include the operator moving his hand in a representation of a check mark to instruct the visualization system 100 to invoke the solution object. In another example, the operator revolving his hand in a circle can be a command to add problem solution data from the machine located at the operator to the data collected by the current process problem model.

The system logging component 406, in another aspect, provides the ability to include any data available to the visualization system from the industrial controller in the problem solution data archiving. The preconfigured problem solution model can have a baseline of data to include based on factors such as the type of problem, location of problem, type of product under manufacture or the type of manufacturing equipment involved in the problem. As the problem solution is determined, the operator can add new solution data to the process problem model or exclude preconfigured data criteria that proved to be irrelevant to the circumstances of the problem at hand.

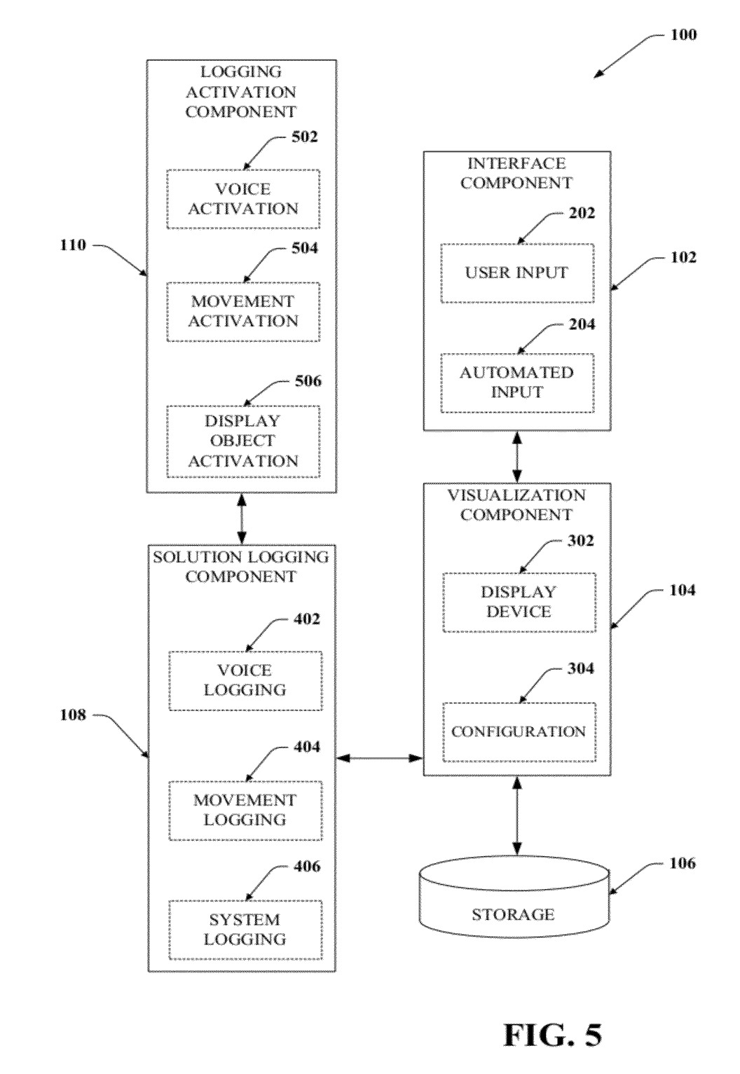

Referring now to FIG. 5, the logging activation component 110 includes a voice activation component 502, a movement activation component 504 and display object activation component 506. In one aspect, the voice activation component 502 allows for the problem solution data collection to be initiated by a single spoken command word or phrase. The word or command phrase is configurable as part of creating the solution object. The visualization system 100 will parse the incoming words for the command word or phrase and upon detecting the activation word or phrase will invoke the solution object just as if the operator had clicked on the solution object on a graphic display. In addition to activating the solution object, the operator cam also speak commands configured to change the preconfigured solution model, add additional data to the preconfigured solution model or remove data from the preconfigured solution model before invoking the solution object.

In another aspect of the subject invention, the movement activation component 504 provides a mechanism for the operator to invoke the solution object by predefined body movements. As described for the voice activation component 502 above, the movements equating to a command to invoke the solution object can be predefined by training the visualization system 100 as to which movements equate to which commands. For example, the visualization system allows the selection of a particular command such as the command to invoke the solution object data collection and then the visualization system 100 is placed in a training mode to illustrate the body movement associated with invoking the command. After the visualization system 100 is trained, the operator can reproduce the movement and the visualization system 100 will detect the movement as an indicator to invoke the associated command.

In a specific example, the visualization system 100 can be trained that when the operator depicts a check mark with his right hand the visualization system detects the movement and invokes the solution object to collect the process data associated with the preconfigured process problem solution model. As with the voice activation component described above, this invocation is identical in effect to the operator selecting the solution object from a graphic display.

In another aspect, the display object activation component 506 is provides a mechanism for configuring one or more graphic displays to allow the operator to activate the solution object by a single click on the graphic display. The solution object may be visually configured to represent any shape or can be a thumbnail or image of the entire process. The chosen shape or image is then associated with the solution object and its invocation method. When the operator determines it is appropriate to collection process problem solution data a simple click on the shape or image initiates the process problem data collection and archiving process. As with the voice activation component 502 and the movement activation component 504, the operator can add additional data or remove preconfigured data collection strategies from the preconfigured process problem data collection model prior to invoking the solution object with a click of the mouse. It should be noted that the solution object on the graphic display can be invoked by other input devices such as a trackball, keyboard, keypad, light pen, stylus, etc.

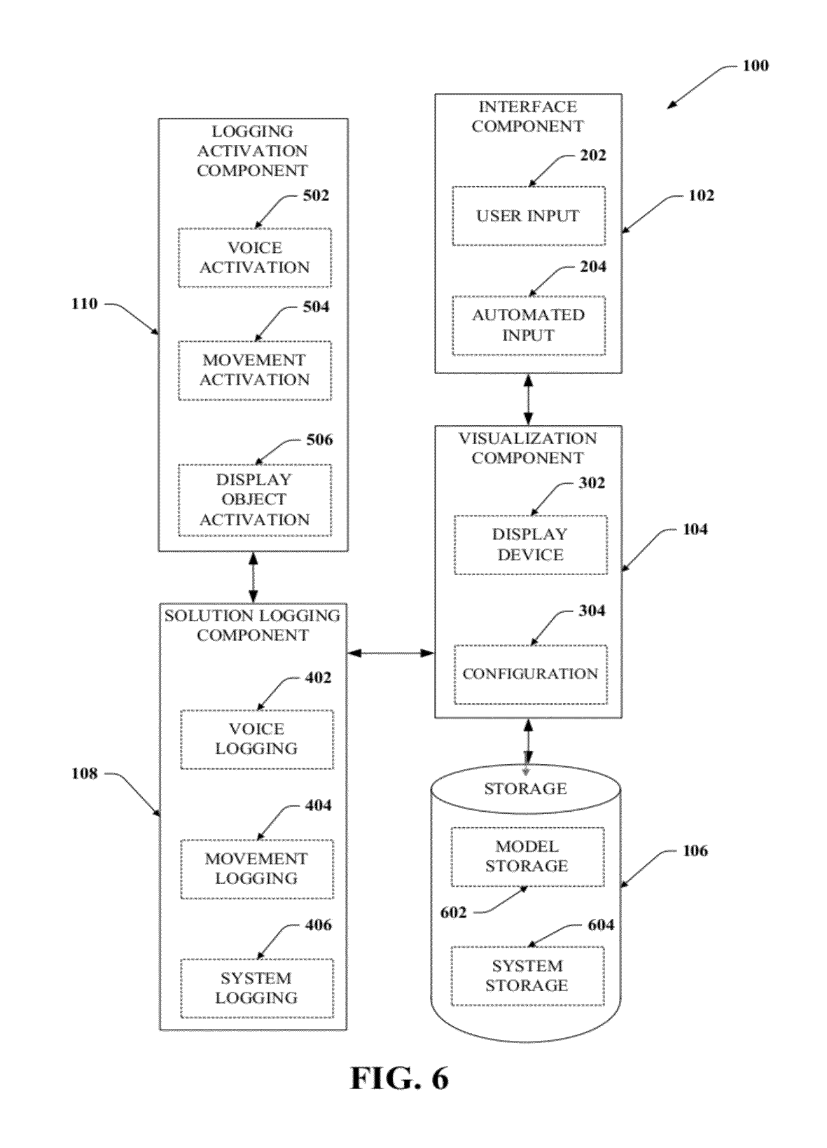

Referring now to FIG. 6, the storage component 106 includes a model storage component 602 and a system storage component 604. Storage component 106 can be any suitable data storage device (e.g., random access memory, read only memory, hard disk, flash memory, optical memory), relational database, XML, media, system, or combination thereof. The storage component 106 can store information, programs, historical process data and the like in connection with the visualization system 100. In one aspect, the model storage component provides the capability to store a plurality of preconfigured process problem solution models. The preconfigured process problem solution models can be organized by any criteria and made available for selection by the operator. For example, the operator can choose a preconfigured process problem solution model based on the production line type or on a particular machine operating as part of the production line.

At the operators' discretion, new models can be created and stored based on changes to the production line or a particular machine. The operator can also combine multiple models to create a new larger data view model. For example, the operator can select a bottle filler machine, a bottle capper machine and a bottle labeler machine to create a bottling line preconfigured process problem solution model. The operator can then exclude the detailed information about each machine and include more general information related to the overall production line. When the operator invokes the solution object of this new model, the newly configured process problem solution data is collected. The model storage component 602 also allows the preconfigured process problem solution models to be shared with server data stores 1330 or other visualization systems 100 through any of the communicatively connected systems.

In another aspect, the system storage component 604 provides storage for all the components required to operate the visualization system 100 and the process problem data collected based on operator invocation of the solution object. As with the preconfigured process problem solution models, the collected process problem solution data can be shared among server data stores 1330 or other visualization systems 100. A maintenance system associated with the system storage component 604 provides for automatically backing up changed preconfigured process problem solution models and process problem data based on a timed frequency and an indication that the system storage component 604 is reaching full capacity.

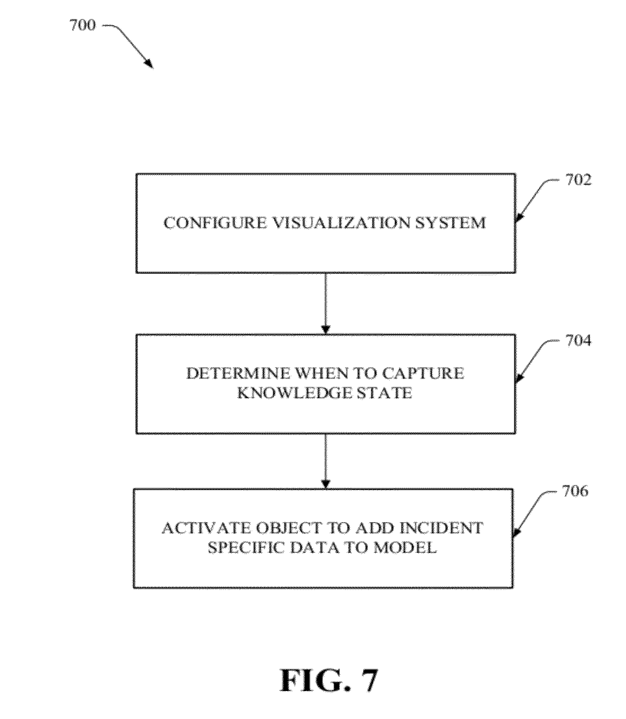

Referring now to FIG. 7, a method 700 of capturing a process problem solution including information associated with operator specific knowledge is illustrated. In one aspect at 702, the visualization system 100 is configured for process operation. The visualization system 100 configuration includes creating graphic displays representing the process, configuring a solution object to include on one or more of the graphic displays and selecting a preconfigured process problem solution model as a basis for collecting process problem solution data.

In another aspect at 704 of the method 700 of capturing operator knowledge associated with a process problem solution, a determination is made by the operator of when to invoke the solution object and capture the process problem data and the operator data associated with the process problem. The operator, as described earlier, can adjust the data collection strategy before invoking the solution object if it is desired to collect more, less or different data than currently configured in the preconfigured process problem solution model.

In another aspect at 706 of the method 700 of capturing operator knowledge associated with a process problem solution, as described earlier, the operator can invoke the solution object by a predefined voice command or phrase, a predefined body movement or by selecting the solution object on a graphical display at the visualization system 100. The solution object then collects the required data from the industrial controller, combines this with the record of the operators' voice recordings and movements and saves the resultant information to the storage component 106. If desired, the updated preconfigured process problem solution model and the collected process problem data can be transferred to any server data store 1330 or visualization system communicatively connected to the subject visualization system 100.

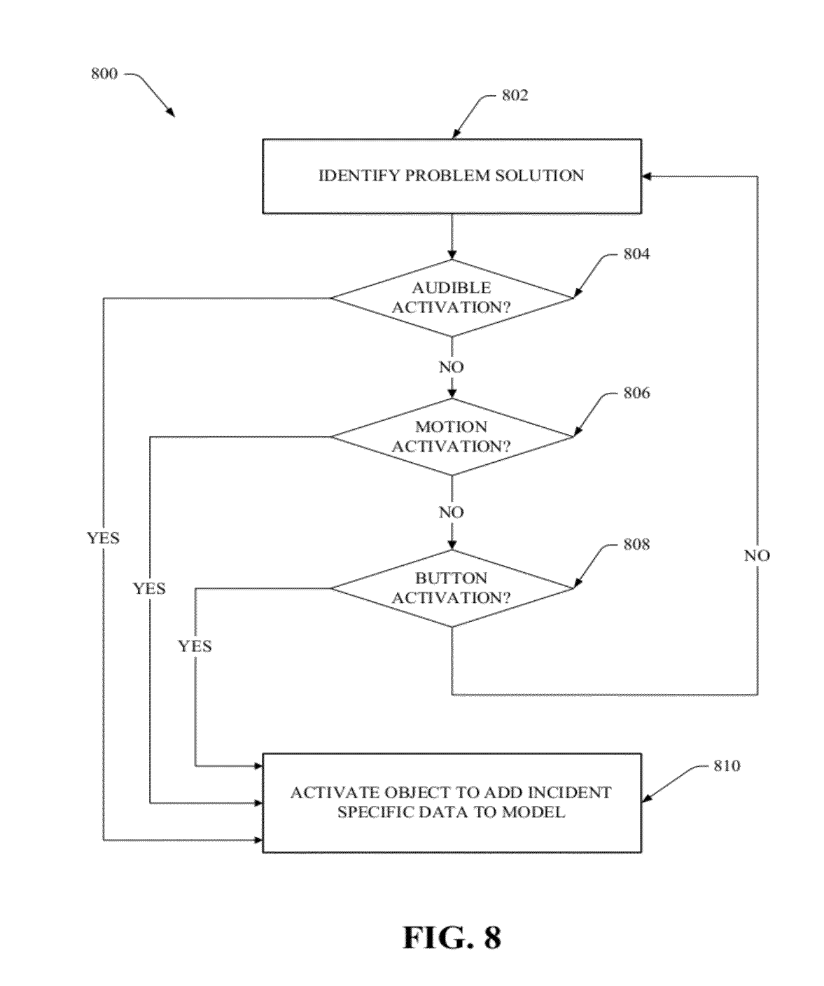

Referring now to FIG. 8, a method 800 is illustrated showing the different and simultaneously compatible methods of activating the solution object. In one aspect at 802, the operator identifies a solution to process problem and adjusts the process problem data collection strategy if necessary. In another aspect at 804, 806 and 808, the operator decides which activation mechanism to use in selecting the solution object and initiating the process problem data collection. The operator is not restricted to using a single method and can select different methods based on the circumstances. For example, in a solution to a problem requiring substantial manual interaction by the operator at a location far from the visualization system 100, the operator can choose audible activation 804 or motion activation 806. Under other circumstances where the operator is close to the visualization system 100 or decides to make substantial changes to the preconfigured process problem solution model, the operator can return to the visualization system and interact with the graphic display to ease the reconfiguration task. In either case, when the operator is ready, the process problem solution data can be collected and archived based on a single action by the operator as illustrated at 810.

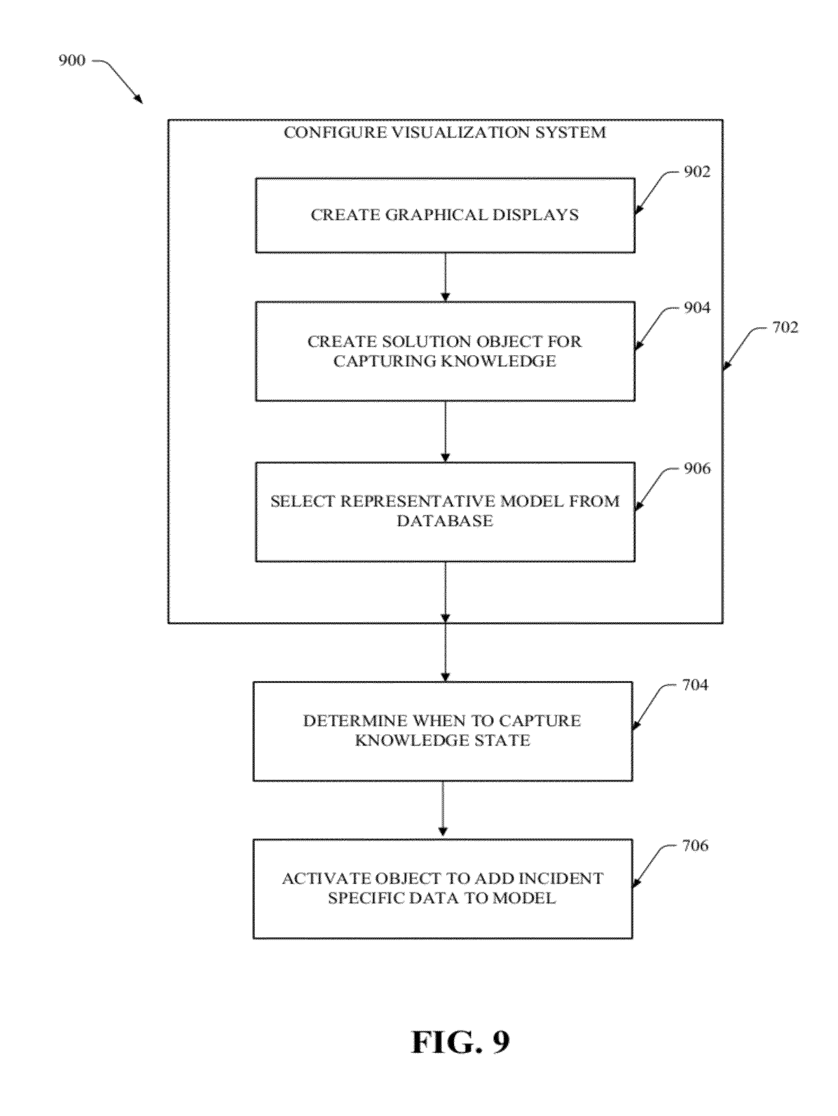

Referring now to FIG. 9, a method 900 illustrates configuring a visualization system 100 for creating a solution to a process problem. Graphical displays representing the process and the component operations to the desired level of detail are created at 902. In another aspect, the solution object is created at 904 and added to any or all of the graphical displays, depending on the preferences of the operator and local convention. The solution object can contain one or more of the activation mechanisms previously described for method 800 and access security credentials may be required to invoke the solution object depending on the configuration provided. The security credentials can be required for one activation method and not required for another. For example, security credentials may not be required to invoke the solution object because the visualization system is located in a secure control room but may be required for voice activation because the voice activation system is located away from the control room and may be implemented with a wireless system that could receive transmissions from outside of the process area.

In another aspect of the subject invention, a preconfigured process problem solution model can be selected at 906 as a basis for process problem solution data collection. The model can represent the entire process, a particular unit operation of the process or a single machine in the process. The scope of the model represents the detail of the data that will be collected when the solution object is invoked. Process problem solution models are the primary mechanism of sharing operator experience and intelligence with different operators and locations.

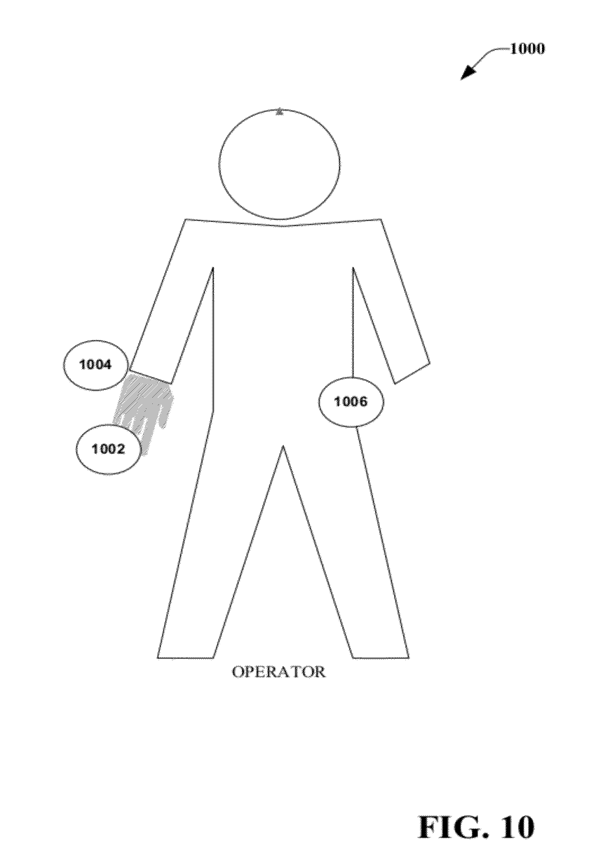

Referring now to FIG. 10, an operator 1000 is represented wearing motion detection apparatus. In one aspect, motion device 1002 is a glove, ring or similar device containing motion detection capabilities to determine the movement of the hand and the position of the hand within the process area. The visualization system 100 is capable of tracking motion device 1002 as the operator moves about the process and interacts with different machines as the process problem is analyzed and an appropriate solution is determined. For example, the visualization system 100 can determine movement to a precision allowing the visualization system 100 to detect the movement of the operators hand in a motion depicting a check mark to indicate invocation of the solution object.

In another aspect, a motion device 1004, in a configuration similar to a wrist watch or bracelet provides for interaction with the visualization system 100 to acknowledge a request for security credentials or to change the preconfigured process problem solution model. The motion device 1004 can also function as a motion tracking device as described for motion device 1002.

In another aspect, a motion device 1006, in a configuration of a device similar to a pager attached to a belt, provides the ability to track the movements of the operator and provide an interface for acknowledging requests for security credentials. The motion device 1006 can also be held in the hand and used to allow the visualization system 100 to detect the operators' hand motions. In another aspect, the motion device 1006 has a greater battery capacity and a more powerful transmitter allowing motion device 1006 to remain at greater distances in the process area for longer periods of time before requiring a recharge.

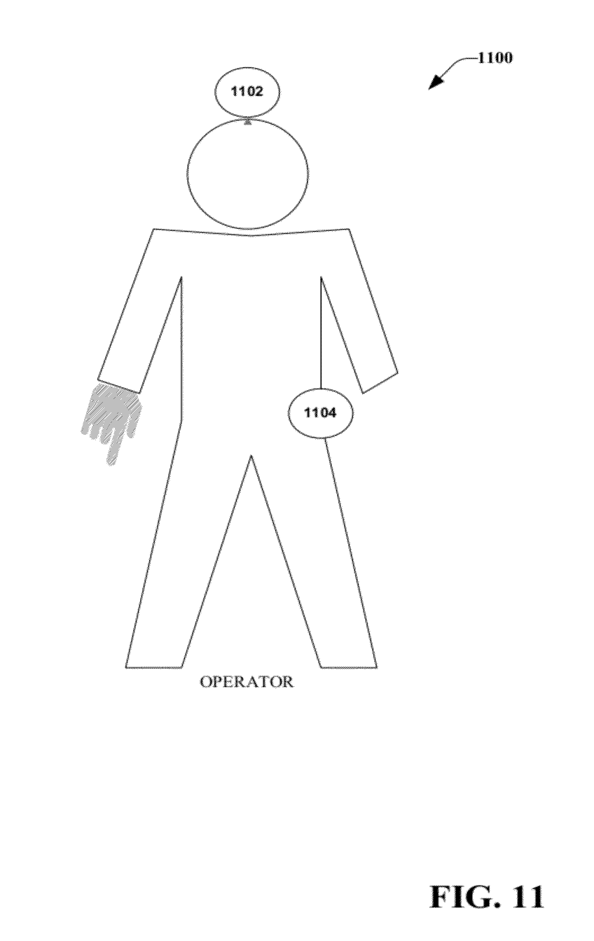

Referring now to FIG. 11, an operator 1100 is represented wearing a voice communication apparatus. In one aspect, a headset and microphone 1102 allows the operator to send voice commands and data to the visualization system 100. The operator can receive an audible feedback tone or voice to confirm receipt of his communication.

In another aspect, an operator is represented wearing a device similar in physical configuration to motion device 1006 except communication device 1104 is a transmitter and receiver. Communication device 1104 also contains a more powerful battery and transmitter allowing the operator to proceed to greater distances from the visualization system 100 for greater periods of time before requiring a recharge of communication unit 1104.

Although not required, the claimed subject matter can partly be implemented via an operating system, for use by a developer of services for a device or object, and/or included within application software that operates in connection with one or more components of the claimed subject matter. Software may be described in the general context of computer executable instructions, such as program modules, being executed by one or more computers, such as clients, servers, mobile devices, or other devices. Those skilled in the art will appreciate that the claimed subject matter can also be practiced with other computer system configurations and protocols, where non-limiting implementation details are given.

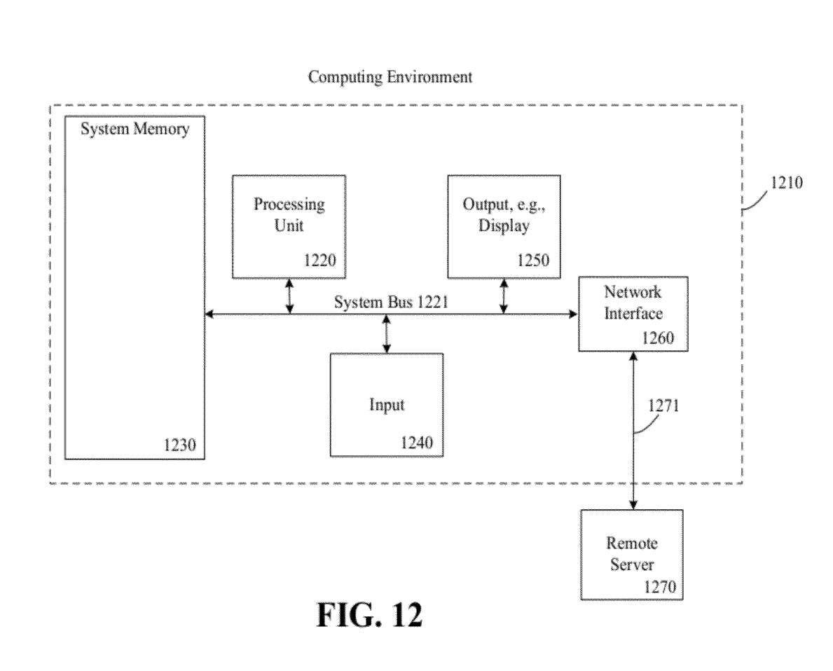

FIG. 12 thus illustrates an example of a suitable computing system environment 1200 in which the claimed subject matter may be implemented, although as made clear above, the computing system environment 1200 is only one example of a suitable computing environment for a mobile device and is not intended to suggest any limitation as to the scope of use or functionality of the claimed subject matter. Further, the computing environment 1200 is not intended to suggest any dependency or requirement relating to the claimed subject matter and any one or combination of components illustrated in the example operating environment 1200.

With reference to FIG. 12, an example of a remote device for implementing various aspects described herein includes a general purpose computing device in the form of a computer 1210. Components of computer 1210 can include, but are not limited to, a processing unit 1220, a system memory 1230, and a system bus 1021 that couples various system components including the system memory to the processing unit 1220. The system bus 1221 can be any of several types of bus structures including a memory bus or memory controller, a peripheral bus, and a local bus using any of a variety of bus architectures.

Computer 1210 can include a variety of computer readable media. Computer readable media can be any available media that can be accessed by computer 1210. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media can embody computer readable instructions, data structures, program modules or other data in a modulated data signal such as a carrier wave or other transport mechanism and can include any suitable information delivery media.

The system memory 1230 can include computer storage media in the form of volatile and/or nonvolatile memory such as read only memory (ROM) and/or random access memory (RAM). A basic input/output system (BIOS), containing the basic routines that help to transfer information between elements within computer 1210, such as during start-up, can be stored in memory 1230. Memory 1230 can also contain data and/or program modules that are immediately accessible to and/or presently being operated on by processing unit 1220. By way of non-limiting example, memory 1230 can also include an operating system, application programs, other program modules, and program data.

The computer 1210 can also include other removable/non-removable, volatile/nonvolatile computer storage media. For example, computer 1210 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 1221 through a non-removable memory interface such as an interface, and a magnetic disk drive or optical disk drive can be connected to the system bus 1221 by a removable memory interface, such as an interface.

A user can enter commands and information into the computer 1210 through input devices such as a keyboard or a pointing device such as a mouse, trackball, touch pad, and/or other pointing device. Other input devices can include a microphone, joystick, game pad, satellite dish, scanner, or the like. These and/or other input devices can be connected to the processing unit 1220 through user input 1240 and associated interface(s) that are coupled to the system bus 1221, but can be connected by other interface and bus structures, such as a parallel port, game port or a universal serial bus (USB). A graphics subsystem can also be connected to the system bus 1221. In addition, a monitor or other type of display device can be connected to the system bus 1221 via an interface, such as output interface 1250, which can in turn communicate with video memory. In addition to a monitor, computers can also include other peripheral output devices, such as speakers and/or a printer, which can also be connected through output interface 1250.

The computer 1210 can operate in a networked or distributed environment using logical connections to one or more other remote computers, such as remote server 1270, which can in turn have media capabilities different from device 1210. The remote server 1270 can be a personal computer, a server, a router, a network PC, a peer device or other common network node, and/or any other remote media consumption or transmission device, and can include any or all of the elements described above relative to the computer 1210. The logical connections depicted in FIG. 12 include a network 1271, such local area network (LAN) or a wide area network (WAN), but can also include other networks/buses. Such networking environments are commonplace in homes, offices, enterprise-wide computer networks, intranets and the Internet.

When used in a LAN networking environment, the computer 1210 is connected to the LAN 1271 through a network interface or adapter. When used in a WAN networking environment, the computer 1210 can include a communications component, such as a modem, or other means for establishing communications over the WAN, such as the Internet. A communications component, such as a modem, which can be internal or external, can be connected to the system bus 1221 via the user input interface at input 1240 and/or other appropriate mechanism. In a networked environment, program modules depicted relative to the computer 1210, or portions thereof, can be stored in a remote memory storage device. It should be appreciated that the network connections shown and described are exemplary and other means of establishing a communications link between the computers can be used.

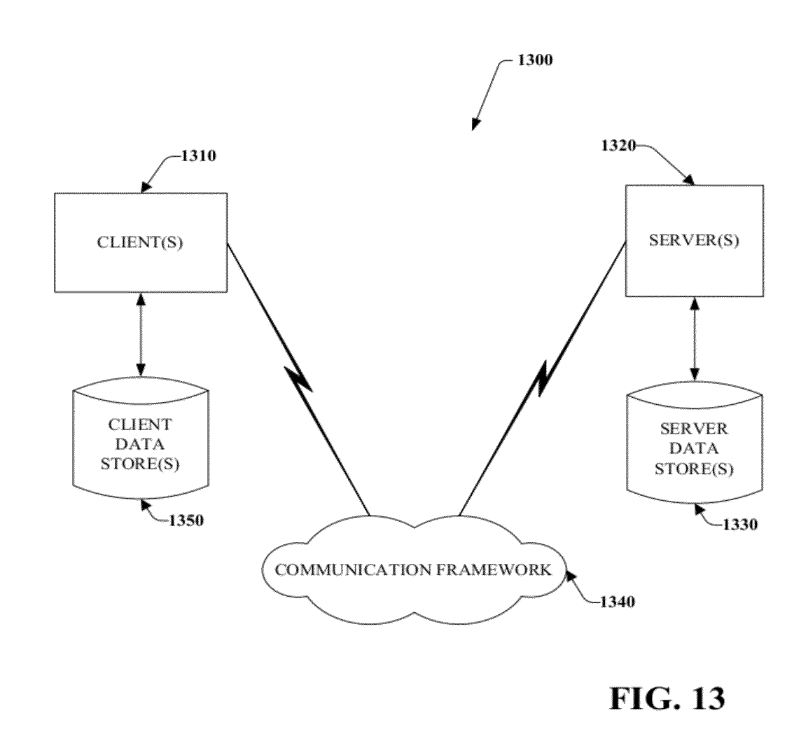

FIG. 13 is a schematic block diagram of a sample-computing environment 1400 within which the disclosed and described components and methods can be used. The system 1300 includes one or more client(s) 1310. The client(s) 1310 can be hardware and/or software (for example, threads, processes, computing devices). The system 1300 also includes one or more server(s) 1320. The server(s) 1320 can be hardware and/or software (for example, threads, processes, computing devices). The server(s) 1320 can house threads or processes to perform transformations by employing the disclosed and described components or methods, for example. Specifically, one component that can be implemented on the server 1320 is a security server. Additionally, various other disclosed and discussed components can be implemented on the server 1320.

One possible means of communication between a client 1310 and a server 1320 can be in the form of a data packet adapted to be transmitted between two or more computer processes. The system 1300 includes a communication framework 1340 that can be employed to facilitate communications between the client(s) 1310 and the server(s) 1320. The client(s) 1310 are operably connected to one or more client data store(s) 1350 that can be employed to store information local to the client(s) 1310. Similarly, the server(s) 1320 are operably connected to one or more server data store(s) 1330 that can be employed to store information local to the server(s) 1340.

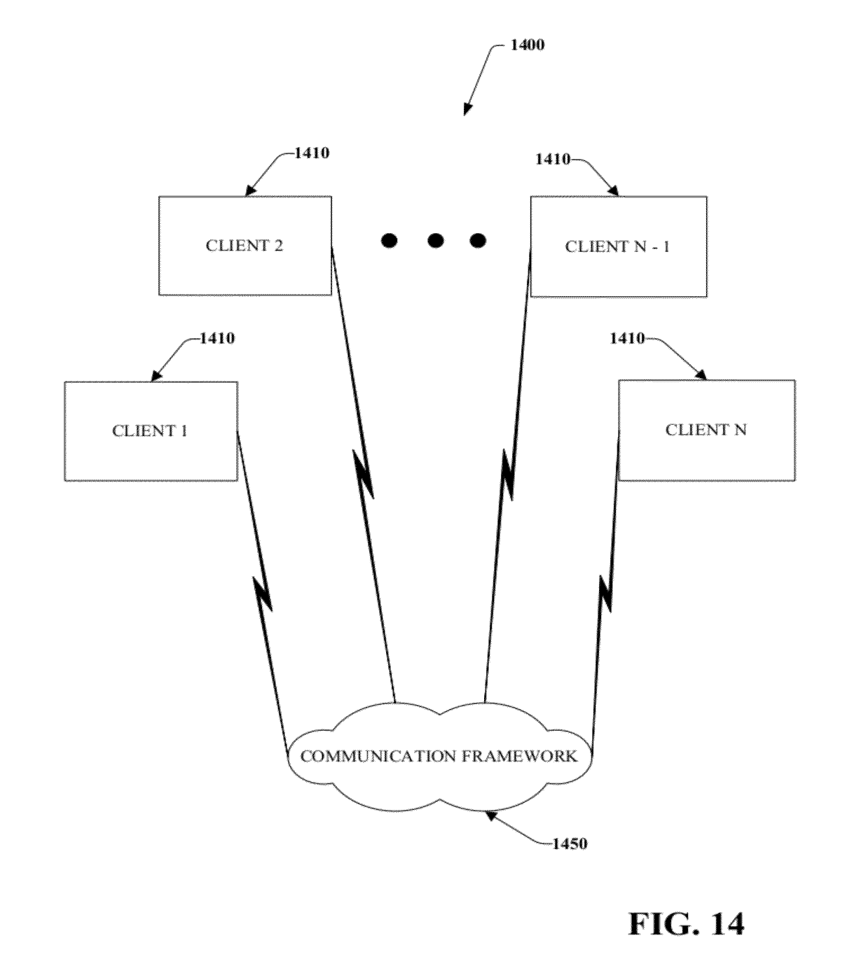

Referring again to the drawings, FIG. 14 illustrates an embodiment of the subject invention where a plurality of client systems 1310 can operate collaboratively based on their communicative connection. For instance, as described previously, a visualization system 100 can transmit an updated preconfigured process problem solution model to a plurality of visualization systems 100 to share the experience and knowledge of an operator with others. In another example, the visualization systems 100 can operate in a series fashion, allowing an operators' communication received by visualization system client 1 to transmit the information to visualization system 100 client 2 which proceeds to transfer the information to visualization system 100 client N-1 and in a similar fashion transmits the information to visualization system 100 client N where the information is transmitted to a server 1320.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, no single embodiment shall be considered limiting, but rather the various embodiments and their equivalents should be construed consistently with the breadth, spirit and scope in accordance with the appended claims.

While, for purposes of simplicity of explanation, the methodology is shown and described as a series of acts, it is to be understood and appreciated that the methodology is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as described herein.

What is claimed is:

1. A system for logging a solution to an industrial process problem that relates to an industrial automation system, the system comprising:
a computer-readable storage medium storing computer executable components;
a processor, communicatively coupled to the computer-readable storage medium, that facilitates operation of the computer executable components, comprising:
a solution logging component configured to collect data that relates to solution of the industrial process problem, wherein the solution logging component is further configured to collect the data in response to detection of at least one of an execution of an alarm, an execution of a warning, or a maintenance schedule; and
a storage component configured to store at least one of a preconfigured industrial process problem solution or a preconfigured visualization of an industrial process problem solution.

2. The system of claim 1, wherein the solution logging component is further configured to collect operator voice data associated with the solution to the industrial process problem.

3. The system of claim 1, wherein the solution logging component is further configured to collect the data related to the process problem from an industrial automation controller configured to control at least one device associated with the process problem.

4. The system of claim 3, wherein the solution logging component is incorporated into the industrial automation controller configured to control at least one device associated with the process problem.

5. The system of claim 4, wherein the solution logging component is a software layer in the industrial automation controller.

6. The system of claim 1, further comprising a logging activation component configured to interact with an operator to invoke the solution logging component.

7. The system of claim 6, wherein the logging activation component is further configured to invoke the solution logging component based on at least one of receipt of a preconfigured command word or phrase transmitted from a communication device attached to the operator, receipt of a positional indication of the operator's movements transmitted from a device attached to the operator, or the operator selecting the solution object on a graphic display.

8. The system of claim 1, wherein the solution logging component is further configured to facilitate selection of preconfigured process problem solution models archived on the storage component.

9. The system of claim 8, wherein the solution logging component is further configured to facilitate adjustment of a logging strategy in a selected preconfigured process problem solution model.

10. The system of claim 9, wherein the solution logging component is further configured to automatically update communicatively connected visualization systems with modified preconfigured process problem solution models.

11. The system of claim 1, wherein the solution logging component is further configured to track the movement of an operator during the solution of the industrial process problem, wherein the tracking is performed based on movement of a device attached to the operator.

12. The system of claim 11, wherein the solution logging component further comprises a visualization component configured to display the movement of the operator during the solution of the industrial process problem.

13. The system of claim 1, wherein the solution logging component is further configured to:
analyze the collected data; and
update, to incorporate the collected data, at least one of the preconfigured industrial process problem solution to generate an updated industrial process problem solution or update the preconfigured visualization of the industrial process problem solution to generate an updated visualization of the industrial process problem solution.

14. The system of claim 13, the storage component further configured to store at least one of the updated industrial process problem solution or the updated visualization of the industrial process problem solution.

15. The system of claim 14, further comprising a visualization component configured to display at least one of the collected data, the preconfigured industrial process problem solution, the updated industrial process problem solution, the preconfigured visualization of the industrial process problem solution, or the updated visualization of the industrial process problem solution.

16. The system of 14, wherein the solution logging component is further configured to perform automatically at least one of collection of the solution data, initiate storage of the preconfigured industrial process problem solution, initiate storage of the updated industrial process problem solution, initiate storage of the preconfigured visualization of the industrial process problem solution, initiate storage of the updated visualization of the industrial process problem solution, or update, to incorporate the collected data, at least one of the preconfigured industrial process problem solution to generate an updated industrial process problem solution or update the preconfigured visualization of the industrial process problem solution to generate an updated visualization of the industrial process problem solution.

17. A method for logging a solution to an industrial process problem, the method comprising:
detecting data being generated relating to at least one of executing of an alarm, executing of a warning, or a maintenance schedule activating;
invoking a solution logging component;
collecting data pertaining to a solution object of the industrial process problem; and
supplementing at least one of a preconfigured industrial process problem solution or a preconfigured visualization of an industrial process problem solution with at least one of the collected process data or the solution object.

18. The method of claim 17, further comprising:
analyzing the collected data; and
updating, by incorporating the collected data, at least one of:
the preconfigured industrial process problem solution to facilitate generating an updated industrial process problem solution or
the preconfigured visualization of the industrial process problem solution to facilitate generating an updated visualization of the industrial process problem solution.

19. The method of claim 18, further comprising:
storing at least one of the updated industrial process problem solution or the updated visualization of the industrial process problem solution.

20. The method of 19, further comprising automatically performing at least one of collecting the solution data, initiating storage of the preconfigured industrial process problem solution, initiating storage of the updated industrial process problem solution, initiating storage of the preconfigured visualization of the industrial process problem solution, initiating storage of the updated visualization of the industrial process problem solution, or updating, to facilitate incorporating the collected data, at least one of the preconfigured industrial process problem solution for generating an updated industrial process problem solution or updating the preconfigured visualization of the industrial process problem solution for generating an updated visualization of the industrial process problem solution.

21. The method of claim 17, further comprising automatically performing by a software layer comprising an industrial automation controller associated with the industrial automation problem at least one of:
detecting at least one of a data being input relating to an operator, executing of an alarm, executing of a warning, or a maintenance schedule activating,
invoking a solution logging component, collecting data pertaining to a solution object of the industrial process problem, or
supplementing at least one of a preconfigured industrial process problem solution or a preconfigured visualization of an industrial process problem solution with at least one of the collected process data, operator input, or the solution object.

22. A computer-readable non-transitory storage medium comprising computer-executable instructions that, in response to execution, cause a computing system including at least one processor to perform operations, comprising:
detecting, in relation to an industrial process problem, at least one of a executing of an alarm or executing of a warning;
invoking a solution logging component;
collecting data pertaining to a solution object relating to the industrial process problem;
analyzing the collected data; and
supplementing at least one of a preconfigured industrial process problem solution or a preconfigured visualization of an industrial process problem solution with the collected data.

23. The computer readable storage medium of claim 22, the operations further comprising:
updating, by incorporating the collected data, at least one of:
the preconfigured industrial process problem solution to facilitate generating an updated industrial process problem solution or
the preconfigured visualization of the industrial process problem solution to facilitate generating an updated visualization of the industrial process problem solution; and
archiving at least one of the collected data, the solution object, the preconfigured industrial process problem solution, the preconfigured visualization of an industrial process problem solution, the updated industrial process problem solution or the updated visualization of the industrial process problem solution.

24. The computer readable storage medium of claim 23, the operations further comprising:
selecting the preconfigured process problem solution model;
modifying a data collection strategy of the preconfigured process problem solution model; and
sharing at least one of the updated industrial process problem solution or the updated visualization of the industrial process problem solution with a plurality of like computer-implemented systems.

25. The computer readable storage medium of claim 24, wherein the computing system comprises an industrial automation controller controlling a device associated with the industrial process problem.

26. The computer readable storage medium of claim 25, wherein at least one of the operations being performed automatically by the computing system comprising the industrial automation controller controlling a device associated with the industrial process problem.

27. The computer readable storage medium of claim 24, further comprising formatting, facilitating presentation on a visualization device associated with the computing system, at least one of the collected data, at least one operator action captured during solution of the industrial process problem, the solution object, the preconfigured industrial process problem solution, the preconfigured visualization of an industrial process problem solution, the updated industrial process problem solution or the updated visualization of the industrial process problem solution.
